(19) United States
(12) Patent Application Publication
(10) Pub. No.: US 2013/0058352 A1
(43) Pub. Date: Mar. 7, 2013

(54) METHOD AND DEVICE FOR FORWARDING DATA PACKETS

(71) Applicants: Daniel Martin Goergen, Eindhoven (NL); Tim Cornell Wilhelmus Schenk, Eindhoven (NL); Javier Espina Perez, Eindhoven (NL); Maurice Herman Johan Draaijer, Eindhoven (NL)

(72) Inventors: Daniel Martin Goergen, Eindhoven (NL); Tim Cornell Wilhelmus Schenk, Eindhoven (NL); Javier Espina Perez, Eindhoven (NL); Maurice Herman Johan Draaijer, Eindhoven (NL)

(73) Assignee: KONINKLIJKE PHILIPS ELECTRONICS N.V., EINDHOVEN (NL)

(21) Appl. No.: 13/698,379

(22) PCT Filed: May 12, 2011
(86) PCT No.: PCT/IB11/52083

§ 371 Date: Nov. 16, 2012

(30) Foreign Application Priority Data
May 21, 2010 (EP) 10163515.9

(51) Int. Cl. H04L 12/56

(52) U.S. Cl. 370/400

(57) ABSTRACT

The method for forwarding data packets in position based routing of data from a source node (S) to at least one destination node (D) of a mesh network (1) comprises the following steps. A data packet (2) originating from the source node (S) is received at an intermediate node (A) and the geographical position of the destination node (D) is obtained from the data packet (2). All accessible neighbor nodes (Cᵢ) of the intermediate node (A) and their positions are determined. For each neighbor node (Cᵢ) of the intermediate node (A), a deviation value (vᵢ) depending on the position of the neighbor node (Cᵢ) in relation to a line of sight (4) between the intermediate node (A) and the destination node (D) is then determined and at least one of the neighbor nodes (Cᵢ) is selected as a next intermediate node (B) depending on the determined deviation values (vᵢ). The data packed (2) is then forwarded to the selected next intermediate node (B).

### FIELD OF THE INVENTION

The invention relates to a method for forwarding and a method for routing data packets in position based routing of data from a source node to at least one destination node in a mesh network. The invention further relates to a routing device for use in a mesh network suited to perform said methods.

### BACKGROUND OF THE INVENTION

Mesh networks, and in particular wireless, e.g. radio-frequency, mesh networks, become increasingly important for applications such as lighting control, building automation, monitoring applications (“sensor networks”) and medical applications.

In a mesh network, routing is not a task that is performed by specifically dedicated devices (“routers”), but by more or less all devices positioned at network nodes. Every node may act as a router and forward a message, or, more specifically, data packets that make up the message, to a neighbored node. The data packets are thus transported from the source node to the destination node via a number of intermediate nodes in a multi-hop routing process. A variety of routing mechanisms for such a multi-hop routing process have been developed. These routing mechanisms are furthermore usually designed to cope with dynamic network structures with devices joining and leaving the network at any time or changing their positions, and with potentially instable wireless transmissions, e.g. due to shielding, reflections or interferences.

A favored kind of a multi-hop routing mechanism is called geographic routing. In geographic routing, also referred to as position- or location-based routing, the geographic positions of the nodes are taken into account. It is assumed that every node knows its own position and the position of its neighbors. Furthermore, the source node that sends a message knows the position of the destination node and encodes the position of the destination within the message, for example in a header of each data packet the message consists of. Every intermediate node then forwards a received data packet to one of its neighbors, depending on its own position, the position of the neighbors and the position of the destination.

In a well-known approach, called “greedy forwarding”, each node forwards the data to the one of its neighbors that is closest to the destination. Greedy forwarding is a straightforward approach that is easy to implement since it only uses local information. However, it bears the danger of a message getting trapped on its way, even if a potential route exists. This problem is known as the “greedy routing failure”. For example, a first intermediate node sends a data packet to a second intermediate node that is positioned closer to the destination node than all other neighbors of the first intermediate node. If then the first node was closer to the destination node than all other neighbors of the second intermediate node, the data packed would be trapped between the first and the second intermediate node. Using the terminology of optimization strategies, the data packed would be trapped in a “local minimum”.

In order to still be able to deliver a message, the routing process is usually stopped in case of a greedy routing failure and the message is re-sent by the source node as a broadcast message that is forwarded by all nodes in the network. Such a “flooding of the network” ensures that the message reaches its destination—at the cost of a large data volume that has to be transmitted in total. In particular in large networks, typically in networks with more than a few hundred nodes, the data overhead due to broadcast messages starts impacting the overall achievable data rate. Data collisions are more likely to occur, further reducing the overall performance. Additionally, the probability that a greedy routing failure occurs increases with increasing network size.

In the field of lighting control, remote management of outdoor luminaires, for example street-lights, via radio-frequency network technologies is recently receiving increasing interest. In systems for the remote management of outdoor luminaires, for example in a city-wide network with the street light poles being the nodes, the number of nodes can be much larger than in applications like building automation or medical applications. In such a scenario, the greedy routing failure is likely to occur: Buildings are blocking the direct line-of-sight to the next node that would be preferred by the greedy routing protocol. Also free-space areas without light poles, like parks, lakes or large parking areas, are obstacles in the direct path.

In the Article “Geographic Routing in City Scenarios” by C. Lochert et al., Mobile Computing and Communications Review, Volume 9, Number 1, a routing mechanism is described that combines greedy routing with a repair strategy. The repair strategy is based on coordinator nodes positioned at critical positions, e.g. at street junctions and performing a forwarding strategy that differs from the plain greedy forwarding. A disadvantage is that the routing is less flexible concerning the topology of the network. Furthermore, coordinator nodes have to be determined in advance, which is less flexible concerning the topology of the network, or have to be determined in an automatic fashion, which complicates the system and might add additional overhead to the network traffic.

It would therefore be advantageous to achieve methods for forwarding and routing data packets in a mesh network that work effectively even in large networks and are easy to implement. It would further be advantageous to achieve a routing device performing this forwarding method for an effective routing.

### SUMMARY OF THE INVENTION

The present application contemplates a method for forwarding data packets in position based routing of data from a source node to at least one destination node of a mesh network that comprises the following steps. A data packet originating from the source node is received at an intermediate node and the geographical position of the destination node is obtained from the data packet. All accessible neighbor nodes of the intermediate node and their positions are determined. For each neighbor node of the intermediate node, a deviation value depending on the position of the neighbor node in relation to a line of sight between the intermediate node and the destination node is then determined and at least one of the neighbor nodes is selected as a next intermediate node depending on the determined deviation values. The data packed is then forwarded to the selected next intermediate node.

Compared to a purely forward-driven routing from the source node to the destination node, the described forwarding method leads to a routing path that deviates from the more direct “greedy” path. The selection criterion thereby allows controlling the deviation. An occurrence of situations, in which a fallback to flooding techniques has to be used, can be prevented by controlling the deviation accordingly.

In a preferred embodiment of the method, the deviation value is related to a distance between the respective neighbor node and the line of sight, and in particular the length of a perpendicular projection from the respective neighbor node and the line of sight. In further preferred embodiments of the method, the deviation value is related to a distance between the respective neighbor node and the intermediate node, or is related to an angle between the line of sight and a line connecting the intermediate node. All cases provide a straightforward criterion for determining the next intermediate node that deviates from the known greedy forwarding in a controllable manner.

The present application further contemplates a method for routing and a routing device that both make use of the above forwarding method.

Further advantageous embodiments are provided in the respective dependent claims. Still further advantages and benefits of the present invention will become apparent from and elucidated with reference to the embodiments described hereinafter in connection with the drawings.

### BRIEF DESCRIPTION OF THE DRAWINGS

In the drawings:

FIG. 1 shows a schematic drawing of section of a mesh network in a first example;

FIG. 2 shows examples of different routing paths from a source node to a destination node;

FIG. 3 shows a further example of a routing path from a source node to a destination node;

FIG. 4 shows an enlargement of a part of FIG. 1;

FIG. 5 shows a flow chart of a method for forwarding a data packet; and

FIG. 6 shows a schematic drawing of section of a mesh network in an example illustrating multicast routing.

### DETAILED DESCRIPTION OF EMBODIMENTS

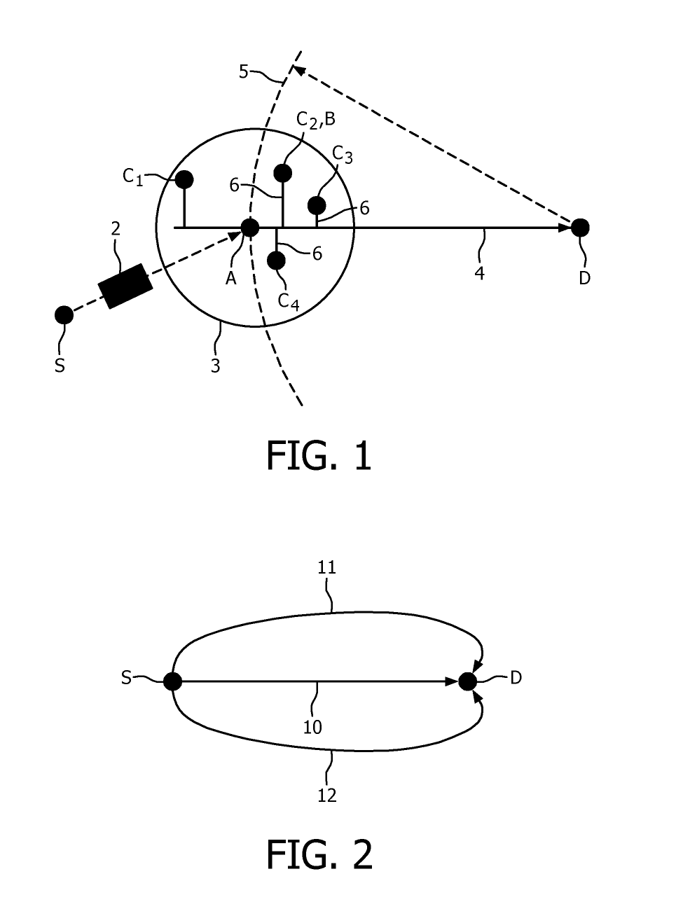

FIG. 1 shows a section of a mesh network 1. A data packet 2 as part of a message is being sent from a source node S to a destination node D via an intermediate node A and a next intermediate node B. For the intermediate node A, its neighbor nodes Cᵢ are depicted, with i ranging from 1 to 4 in the shown case.

By way of example, the mesh network 1 of FIG. 1 could be a lighting control system for a remote management of street light poles. The source node S would then correspond to a control center and the further nodes A, B, C and D would correspond to light poles that can be controlled, e.g. switched on and off or be dimmed, and that may at the same time contain sensors, e.g. for measuring the local light intensities. In the depicted situation, the control center (source node S) sends a message, e.g. a control command or a sensor request, to one of the light poles (destination node D) via another light pole (first intermediate node A) that is capable of forwarding the message.

A first embodiment of a method for forwarding a data packet is now described in connection for the situation shown in FIG. 1. It is assumed that the intermediate node A has received the data packet 2, either directly from the source node S or from a preceding intermediate node not shown in the figure.

The intermediate node A first determines all neighbor nodes Cᵢ that are currently active and accessible. This can for example be done by issuing a beacon request which will be answered by all neighbor nodes Cᵢ within reach, here by nodes C₁ to C₄. The reach of the intermediate node A is depicted as a circle 3 in the figure. If a neighbor node Cᵢ answers a beacon request it encloses information on its own position in the answer. Accordingly, the intermediate node A gains knowledge about its accessible neighbor nodes Cᵢ, as well as their position. The beacon request may also be sent proactively, e.g. in regular time intervals, such that information on the neighbor nodes Cᵢ is already available at the intermediate node A when it is needed. Alternatively, in particular in static systems where the nodes do not move, accessibility can be checked on the basis of lists of neighboring nodes that are stored in each node. In such a case, the position of the neighbor nodes Cᵢ does not have to be transmitted every time but can be enclosed in the stored lists.

The destination node D and its position are enclosed in the data packed 2, for example as part of a header portion of the data packet 2. Generally, the destination node D does not have to be specified itself (e.g. by an identification number), the destination position would be sufficient. The destination's position as well as all other position information in the system could for example be stored in form of GPS—(Global Positioning System) coordinates. In case one of the neighbor nodes Cᵢ would be the destination node D, the data packet 2 would be forwarded to the destination node D immediately and the routing process would be finished. Otherwise, a line-of-sight 4 from the position of the intermediate node A to the position of the destination node D read from the data packet 2 is drawn. Furthermore, an imaginary circle 5 (depicted by a dashed line) around the destination node D with a radius equal to the distance between the intermediate node A and the destination node D is drawn. When forwarding the data packet 2 to one of the neighbor nodes Cᵢ as a next intermediate node, only neighbor nodes Cᵢ that are positioned within the circle 5 would lead to a forward progress of the data packet, i.e. would bring the data packet 2 closer to its destination. Accordingly, only neighbor nodes Cᵢ that are positioned within the dashed circle 5 are considered as candidates for the next intermediate node in the following. In the example shown, neighbor node Cᵢ is thus ruled out.

Then for each remaining neighboring node Cᵢ (here nodes C₂ to C₄) its distance 6 to the line-of-sight 4 is determined by drawing a perpendicular from the respective neighboring node Cᵢ to the line-of-sight 4 and by calculating the length of the perpendicular.

In one embodiment of the method, the neighbor node Cᵢ that has the largest distance 6 to the line-of-sight 4 is chosen as the next intermediate node B. In the example shown, the neighboring node C₂ would accordingly be the next intermediate node B to which the intermediate node A would forward the data packet 2.

In an alternative embodiment of the method, it is additionally taken into account whether a neighboring node Cᵢ is positioned on the left or right hand side of the line-of-sight 4. Left and right are judged with respect to the direction towards the destination node D, i.e. in the example shown, the neighbor nodes C₂ and C₃ are left of the line-of-sight 4 and the neighbor node C₄ is right of the line. A predetermined control variable α is defined that selects a desired side. If, for example, α equals 1, the next intermediate node B is selected from neighbor nodes Cᵢ left of the line-of-sight 4 only, and if α equals −1, the next intermediate node B is selected from neighbor nodes Cᵢ right of the line-of-sight 4 only. For α=1, the neighbor node C₂ would again be the next intermediate node B to which the intermediate node A would forward the data packet 2. However, for α=−1, the neighbor node C₄ would be selected as the next intermediate node B to which the intermediate node A would forward the data packet 2.

The control value α could for example be enclosed in the data packet 2 and used as a parameter controlling the routing process. Its impact on the routing path from the source node to the destination node is schematically depicted in FIG. 2. The figure shows the network 1 on a large scale without any details and without intermediate nodes. Compared to an imaginary direct path 10 from the source node to the destination node D, a control value α=1 leads to a deviated path 11 with a clockwise spin, while a control value α=−1 leads to a deviated path 12 with an anti-clockwise spin. According to this behavior, the shown forwarding method can be designated as “spin-greedy” routing: “spin” for the deviation from the imaginary direct path and “greedy” for the limitation to intermediate nodes connected with a forward progress (dashed circle 5 in FIG. 1).

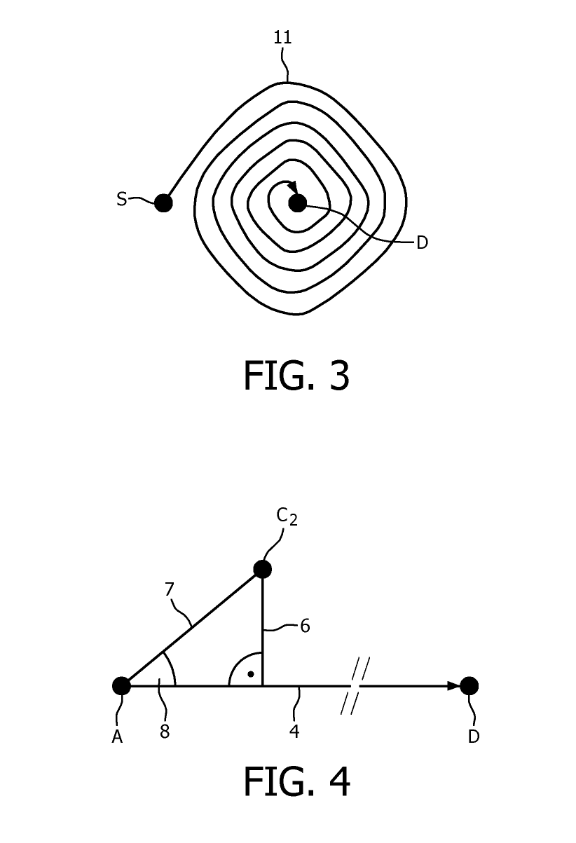

In a situation, in which the selected next intermediate node is always a node with a very low progress towards the destination, the routing path will accordingly spiral around the destination node D, as shown schematically in FIG. 3 for a deviated path 11 with a clockwise spin.

The control option that the control variable a provides can be used to decrease the occurrence of situations, in which a fallback to flooding techniques has to be used. In case a data packet that was sent by a source node S with a certain value of the control variable, e.g. α=1, can not be delivered because it ran in a local minimum, it can be re-sent with the inverse value for the control variable, e.g. α=−1, which increases the possibility to deliver the data packet without flooding the network. Only if this failed again, a flooding technique would have to be used. At the source node, an unsuccessful delivery can either be determined by the packet being flooded back to the source node S, or by a time-out, i.e. a missing acknowledgment statement after a certain waiting period.

In further alternative embodiments, other criteria than the distance between a neighboring node Cᵢ and the direct line 4 are used to determine the next intermediate node B. FIG. 4 shows a section of FIG. 1 to illustrate these further embodiments. One option is to select the next intermediate node B dependent on a distance 7 from the intermediate node A to a neighbor node Cᵢ (by way of example here node C₂). Another option is to select the next intermediate node B dependent on an angle 8 between the direct line 4 and the line connecting the intermediate node A and the neighbor node Cᵢ.

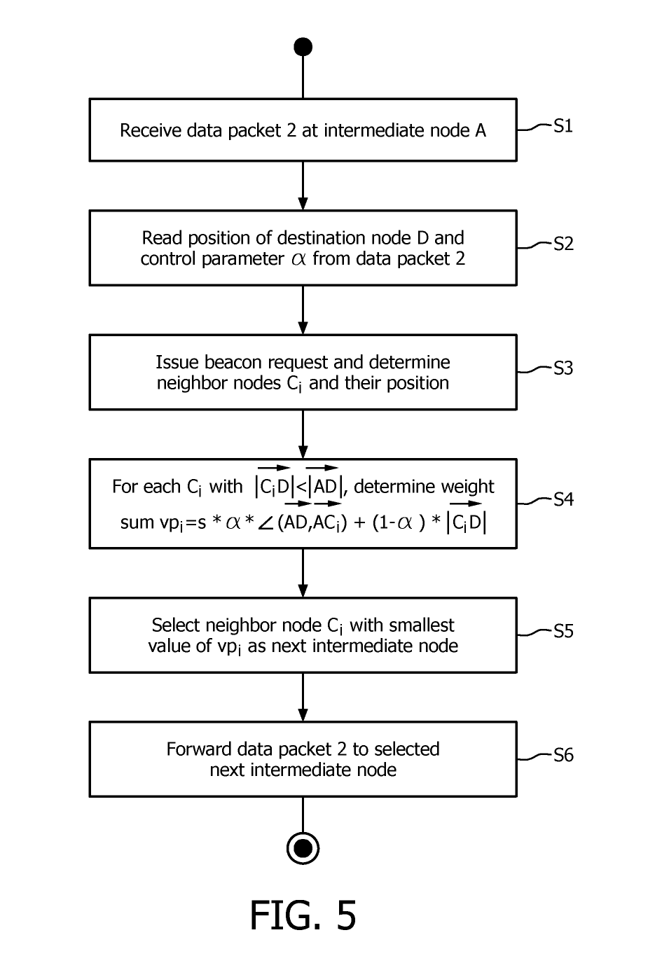

FIG. 5 is a flow chart of a further embodiment of a method for forwarding data packets in a mesh network. The same reference numerals denote the same elements or elements with a comparable function as in afore described figures. In this embodiment, the spin-greedy forwarding method explained in connection with FIGS. 1 to 4 is supplemented by a known greedy forwarding component (called “plain-greedy” component in the following for an easier distinction from the spin-greedy component). In the example, the known greedy forwarding component is based on the neighbor node that is closest to the destination. If used alone, a routing method based on this criterion is known as MFR—(Most Forward in Reach) greedy routing. However, all other kinds of plain-greedy approaches are applicable as well.

The forwarding method starts with a step S1, in which an intermediate node A receives a data packet 2 sent by a source node S and designated for a destination node D.

In a next step S2, the position of the destination node D and a control parameter α are extracted from the header of the data packet 2. The position could for example be comprised in the data packet 2 as GPS-position data. Here, the control parameter α is a variable with fractional numbers ranging between −1 and 1.

In a next step S3, a beacon request is issued by the intermediate node in order to determine its active and responsive neighbors. From the response to the beacon request, a list of neighbor nodes Cᵢ is created. When responding to the request, each neighbor node Cᵢ also transmits its position, which is stored as well. As described above, the beacon request may also be sent proactively, e.g. in regular time intervals, such that information on the neighbor nodes Cᵢ is already available at the intermediate node A when it is needed. Also alternative methods to determine the neighbor nodes Cᵢ and their position can be made use of.

In a next step S4, at first all neighbor nodes Cᵢ that are closer to the destination node D than the intermediate node A are determined and selected for proceeding further. If none of the neighbor nodes Cᵢ is closer to the destination node D than the intermediate node A, the method can either stop here, or continue with all neighbor nodes Cᵢ being selected for proceeding further. Next, each selected neighbor node Cᵢ is rated with a characteristic number, named combined value vpᵢ, which is used to select the next intermediate node. The combined value is a weight sum of two summands that resemble a spin-greedy criterion and a plain-greedy criterion.

In the example shown, the spin-greedy component is based on the angle 8 (compare FIG. 4) between the line of sight 4 and the line connecting the intermediate node A and the respective neighbor node Cᵢ. In the flow chart of FIG. 5, this angle 8 is denoted as ∠(\vec{AD},\vec{ACᵢ}) . This angle 8 is multiplied with the control parameter α as a weighting factor and with a value s that equals −1 if the neighbor node Cᵢ is left of the line of sight 4 and that equals 1 if it is right of the line of sight 4. The effect of the value s will be explained in connection with step S5 of the method.

The plain-greedy component is based on the distance between the respective neighbor node Cᵢ and the destination node D, denoted |\vec{CᵢD}|, and a weighting factor of (1−|α|). A smaller absolute value of the control parameter α thus leads to a bigger influence of the plain-greedy criterion. A higher absolute value (i.e. closer to 1 or to −1) thus favors the spin-greedy behavior.

In a next step 55, the neighbor node Cᵢ with the smallest value of the combined value vpᵢ is then selected as the next intermediate node, to which the data packet 2 is then forwarded in a final step S6. As mentioned above, the absolute value of the control parameter α controls the extent to which spin-greedy behavior or plain-greedy behavior dominates. The sign of the control parameter determines whether the spin is clockwise or anti-clockwise. Since the neighbor node Cᵢ with the smallest value of the combined value vpᵢ is selected, nodes where the control parameter α and the value s have a different sign are preferred. Thus, for positive values of the control parameter α, nodes left of the line-of-sight are preferred, resulting in a clockwise spin of the routing path. For negative values of the control parameter α, nodes right of the line-of-sight are preferred, which results in an anti-clockwise spin of the routing path.

The control parameter α thus allows for a multipath routing protocol with different independent paths and only a very small amount of overhead. The control parameter α is the only additional information which has to be added to the header of a data packet to create an alternative path. For example, three paths can be created by using α=α₁, α=−α₁ and α=0 in three packets which then will follow a clockwise spin, an anti-clockwise spin and a direct path respectively. This will create paths similar to those depicted in FIG. 2. Simulations show that a value of the control parameter α within 0.4-0.6 is advantageous to reduce routing failures.

In particular in more static networks, i.e. networks without moving nodes, the routing method based on the above described method for forwarding data packets can be improved further as follows. A source node can learn the optimal α for a certain destination node over time. This ensures a successful delivery while reducing the amount of overhead. Multiple approaches of learning are possible, all assuming the transmission of an acknowledgment containing the successful α values. The source node can either send multiple packets in parallel or probe different values of the control parameter α (e.g. increasing |α|, both negative and positive) until it receives an acknowledgment. The source node then stores the successful values for the control parameter α and uses the best value (e.g. with respect to the number of forwarding steps) in the future. Only if a value for the control parameter α is (repetitively) unsuccessful, a new value will be probed. In case no value leads to a successful delivery, the protocol falls back to other routing techniques (e.g. flooding) to deliver a data packet.

In an alternative embodiment, multiple packets are always sent out for increased reliability, in particular in case the network topology changes frequently.

While all embodiments described above concern unicast routing, i.e. routing to one destination node, they can be easily extended to multicast routing, i.e. routing to several destination nodes, and more particular to directional flooding. Directional flooding uses position information to bound the flooding to nodes within an area originating at the source and ending of a message, e.g. at a given distance. This area can be described by the positions of the source node and the destination node and either an angle or a target width.

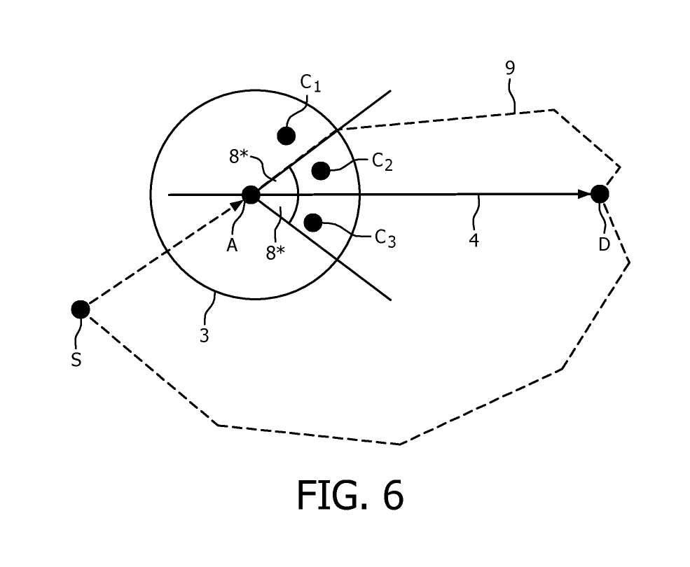

Using the above methods for forwarding and routing, respectively, the target area is defined by a destination position and a threshold parameter. The forwarding method is then modified such that a data packet 2 received by an intermediate node A is sent to all neighbor nodes Cᵢ that fulfill a criterion related to the threshold parameter. The threshold parameter can for example be a certain maximum value for the angle 8 (compare FIG. 4) between the line of sight 4 and the line connecting the intermediate node A and the respective neighbor node Cᵢ, as illustrated in FIG. 6.

FIG. 6 shows a section of a mesh network in a second example in an analogue manner as FIG. 1. A data packet is received at the intermediate node A. A maximum angle 8* is defined as the threshold criterion. The data packet is then sent to all neighbor nodes Cᵢ where the respective angle 8 is smaller than the one specified by the threshold criterion, irrespective whether the node is left or right of the line of sight 4. In the example shown in FIG. 6, the data packet is accordingly forwarded to the neighbor nodes C₂ and C₃. As a result, all nodes within the dotted borderlines 9 receive and forward the data packet. An advantage is that not the whole network is flooded, whereas robustness is created by the multipath approach.

The directional flooding performed with the described multicast and multipath routing can be advantageously used in connection with the remote telemanagement of outdoor luminaires, and in particular street-lights.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method for forwarding data packets in position based routing of data from a source node (S) to at least one destination node (D) of a mesh network (1), the method comprising the steps of:
receiving a data packet (2) originating from the source node (S) at an intermediate node (A) and obtaining the geographical position of the destination node (D) from the data packet (2);
determining all accessible neighbor nodes (Cᵢ) of the intermediate node (A) and their positions;
for each neighbor node (Cᵢ) of the intermediate node (A), determining a deviation value (vᵢ) depending on the position of the neighbor node (Cᵢ) in relation to a line of sight (4) between the intermediate node (A) and the destination node (D);
selecting at least one of the neighbor nodes (Cᵢ) that are closer to the destination node (D) than the intermediate node (A) as a next intermediate node (B) depending on the determined deviation values (vᵢ); and
forwarding the data packed (2) to the selected next intermediate node (B);
wherein a control parameter (α) is included in the data packet 2 and wherein the control parameter (α) controls the determination of the deviation value (vᵢ).

2. The method according to claim 1, wherein the deviation value (vᵢ) is related to a distance (6) between the respective neighbor node (Cᵢ) and the line of sight (4), and in particular the length of a perpendicular projection from the respective neighbor node (Cᵢ) and the line of sight (4).

3. The method according to claim 1, wherein the deviation value (vᵢ) is related to a distance (7) between the respective neighbor node (Cᵢ) and the intermediate node (A).

4. The method according to claim 1, wherein the deviation value (vᵢ) is related to an angle (8) between the line of sight (4) and a line connecting the intermediate node (A) and the respective neighbor node (Cᵢ).

5. The method according to claim 1, wherein the deviation value (vᵢ) is related to a combination of the distance (6) between the respective neighbor node (Cᵢ) and the line of sight (4) and/or a distance (7) between the respective neighbor node (Cᵢ) and the intermediate node (A) and/or an angle (8) between the line of sight (4) and a line connecting the intermediate node (A) and the respective neighbor node (Cᵢ).

6. The method according to claim 1, wherein the selection of the next intermediate node (B) is based on a combined value (vpᵢ) which is a combination of the deviation value (vᵢ) and a progress value (pᵢ) that depends on the position of the respective neighbor node (Cᵢ) with respect to the destination node (D).

7. The method according to claim 6, wherein the combined value (vpᵢ) is a weight sum of the deviation value (vᵢ) and the progress value (pᵢ).

8. The method according to claim 6, wherein the control parameter (α) controls the determination of the combined value (vpᵢ).

9. The method according to claim 8, wherein the control parameter (α) is used for weighting the deviation value (vᵢ) and the progress value (pᵢ) when determining the combined value (vpᵢ).

10. The method according to claim 6, used for multicast routing by sending the data packet (2) to all those neighbor nodes (cᵢ), where the related deviation values (vᵢ) and/or combined values (vpᵢ) fulfill a predetermined threshold criterion.

11. A method for routing a data packet (2) in a mesh network (1) from a source node (S) to at least one destination node (D) via at least one intermediate node (A), wherein the intermediate node (A) performs a method for routing the data packet (2) to a next intermediate node (B) according to claim 1.

12. The method according to claim 11, wherein the source node (S) includes at least one control parameter (α) in the data packet (2) and wherein the at least one control parameter (α) controls the forwarding method for forwarding the data packet (2) at the intermediate node (A).

13. The method according to claim 12, wherein the source node (S) sends the data packet (2) at least two times with differing values for the at least one control parameter (α).

14. The method according to claim 11 used for multicast routing, wherein the source node (S) includes a predetermined threshold parameter related to the threshold criterion that is used to select the neighbor nodes (Cᵢ) to which the data packet (2) is forwarded by the intermediate node (A).

15. A routing device for use at a node of a mesh network (1), the routing device being designed to perform a method for forwarding a data packet (2) according to claim 1.
